(19) United States
(12) Patent Application Publication
(10) Pub. No.: US 2010/0058929 A1
(43) Pub. Date: Mar. 11, 2010

(54) Electric dust collector, discharge electrode, method for producing the discharge electrode, and method for producing discharge needle

(75) Inventors: Mitsuaki Yanagida, Tokyo (JP); Nobuhiko Shiromaru, Tokyo (JP)

Correspondence Address: OLIFF & BERRIDGE, PLC, P.O. BOX 320850, ALEXANDRIA, VA, 22320-4850, US

(73) Assignee: Hitachi Plant Technologies, Ltd., Tokyo (JP)

(21) Appl. No.: 12/310,964

(22) PCT Filed: Sep. 27, 2006
(86) PCT No.: PCT/JP2006/319160

§ 371 Date: Mar. 13, 2009

(51) Int. Cl. B03C 3/41; B05D 5/12; H01J 9/04

(52) U.S. Cl. 96/97; 427/58; 445/50

(57) ABSTRACT

To improve anti-corrosion property in a wet-type electric dust collector while ensuring discharge function.

A coating layer of thermoplastic resin is provided to an entire surface of a needle-type rigid discharge electrode including a support pipe and a discharge needle of an electric dust collector for removing a corrosive mist in an exhaust gas. Then, the coating layer on a tip surface of the discharge needle is coarsely polished and removed to expose a coarse discharge edge surface.

### FIELD OF THE INVENTION

The present invention relates to an electric dust collector, a discharge electrode, a method for producing the discharge electrode, and a method for producing a discharge needle. Especially, the present invention relates to an electric dust collector suitable for removing sulfuric acid and a mist sulfur oxide in exhaust gas, a discharge electrode, which can be applied to the electric dust collector, and a method for producing thereof, and a method for producing a discharge needle.

### DESCRIPTION OF THE RELATED ARTS

Generally in a boiler using fossil fuel such as coal, exhaust gas processing equipment, in which a dry-type electric dust collector and a wet-type electric dust collector provided sequentially, is provided next to a boiler for processing exhaust gas emitted from the boiler. The exhaust gas emitted from the boiler is introduced into the dry-type electric dust collector first and a soot dust is removed. At this time, sulfur oxide such as sulfur dioxide or sulfur trioxide is included in the soot dust and such a sulfur oxide causes metal such as iron to corrode. Subsequently, the exhaust gas is introduced into the wet-type electric dust collector and is discharged outside after misty sulfur oxide and soot dusts which could not be removed by the dry-type dust collector are removed. Meanwhile, part of the sulfur oxide in the exhaust gas is gradually liquidized between the exit of the dry-type electric dust collector and the entrance of the wet-type electric dust collector to generate a mist of sulfur oxide. This mist including sulfuric acid has strong corrosiveness to metals such as iron. Because inside of the wet-type electric dust collector is always exposed to this strong corrosive atmosphere, it becomes necessary to take corrosion of the metal caused by the mist into consideration.

Conventionally, an iron alloy such as stainless material, which is relatively easy to process compared to other metal materials and cheap, has been used for a constituent member of an electric dust collector. However, it is generally known that strength reliability of the iron alloy is significantly decreased under the condition like the dry-type electric dust collector or the wet-type electric dust collector where stress corrosion cracking, hydrogen embrittlement, or potential corrosion easily occurs. In the wet-type electric dust collector, a method of directly spraying water to a discharge electrode or a dust collection electrode as a corrosion prevention countermeasure has been conventionally taken to reduce influence of corrosion by the cleansing effect.

FIG. 14 shows a schematic configuration view of a conventional wet-type electric dust collector. Exhaust gas is introduced from an entrance flange 2 provided on left side of a casing 1 in the figure and discharged from an exit flange 3 on the right side. At the center of the casing 1, a discharge electrode 4 shown in the figure and a dust collection electrode which is not shown in the figure are provided alternately with an interval so that dust charged by corona discharge is collected to the dust collection electrode to be removed. The discharge electrode 4 shown in the figure has a rectangular frame construction which is hung on the upper part of the casing via an insulating glass 5. The discharge electrode 4 includes a discharge electrode frame 6 forming an outer edge and inside of the discharge electrode frame 6, a plurality of support members 7 are vertically aligned. On a side surface of the support member 7, a discharge needle 8 is provided in a protruding manner toward the dust collection electrode facing thereto. As shown in FIG. 15, in the conventional discharge electrode 4, a tip of the discharge needle 8 is sharpened for easy of generation of corona discharge. In such a wet-type electric dust collector, a spraying device having a plurality of nozzles 10 for spraying water supplied by a water supplying pipe 9 is provided in the upper portion of the electrode to directly spray water to the discharge electrode 4 or to the dust collection electrode for the purpose of reducing influence of corrosion by the cleansing effect.

However, according to this method, there are problems that size of the dust collector itself is increased by installing the spraying nozzle and a method for operation and controlling gets complex. Moreover, there are many problems in terms of reliability such as a countermeasure for a case that spraying is stopped. Meanwhile, there is an example where hastelloy alloy material which has stronger anti-corrosion property than the stainless material is used. However, the hastelloy alloy material is difficult to bend or weld and therefore is not suitable for practical usage.

Here, in the Patent Document 1, an example where 11-nylon is coated on the whole of the electrode for the purpose of protecting the discharge electrode is shown. This is mainly aimed at suppressing crack caused by vibration.

Patent Document 1: U.S. Pat. No. 3,957,462

The present invention has been made in consideration of such problems and is aimed at providing an electric dust collector which can improve anti-corrosion property in a wet-type electric dust collector while ensuring discharge function, a discharge electrode, a method for producing the discharge electrode and a method for producing a discharge needle. Moreover, because water spraying equipment becomes unnecessary, size of the wet-type electric dust collector itself can be reduced. Here, similar anti-corrosion effect can also be expected in a case where the present invention is applied to a dry-type electric dust collector.

### SUMMARY OF THE INVENTION

To achieve the above-mentioned purpose, the present invention is a wet-type electric dust collector for removing a mist of sulfur oxide in exhaust gas, wherein after entire surface of a needle-type rigid discharge electrode including a support pipe and a needle is coated by a layer of thermoplastic resin such as polyethylene (PE) or polypropylene (PP), a coating layer of a tip of the needle is coarsely polished to remove the coating and to expose part of the tip of the needle so that the needle is used while the coating layer in the vicinity of the tip of the needle is molten by heat generated by discharge.

In this case, thickness of the coating layer is larger than the diameter of the support pipe in the discharge electrode of the electric dust collector.

According to the present invention, it is not necessary to process the tip of the needle sharply as in a conventional art and therefore it becomes possible to reduce processing procedures of the needle.

Moreover, if the support pipe and the needle are fine, resin layer for coating is thick, and the resin has strength to form a composite material, it becomes possible to significantly reduce weight of the discharge electrode itself compared to a conventional art because specific gravity of the resin is a fraction of a metal. If superior characteristics of resin to bend or twist are used, it becomes possible to realize a discharge electrode which is superior to a conventional one which includes only metal. This is especially effective in a dry-type electric dust collector.

Then, according to the present invention, the entire surface of the needle-type rigid discharge electrode is covered with the resin coating which is not corroded. Therefore, it becomes possible to use stainless materials which are cheap and easy to process under a strong corrosion environment without carrying out cleaning or the like. Moreover, because water spraying equipment for cleaning becomes unnecessary, size reduction of whole of the electric dust collector can be realized.

Further, a discharge electrode according to the present invention includes a coating layer of thermoplastic resin on a surface of the discharge electrode with a discharge needle provided on a side surface of a support member. A tip portion of the discharge needle is cut together with the resin coating layer to have an exposed coarse edge surface. In this case, the support member may include a pipe and the coating layer may be relatively thicker than the thickness of the pipe.

The support member to which the discharge needle is attached may not have a pipe structure and a conductive plate material or a conductive rod may be used as the support member. Further, a manufacturing method of a discharge electrode according to the present invention includes a step of coating a surface of the discharge electrode with a discharge needle provided on a side surface of a support member by thermoplastic resin. Then, a tip portion of the discharge needle is coarsely cut together with the resin coating layer to cause a sharp edge surface of the discharge needle to be exposed outside.

Moreover, according to the present invention, the discharge needle may be covered with a resin coating layer and the tip portion of the discharge needle may be coarsely polished so that a coarsely-polished metal edge surface is exposed.

Further, the discharge needle may be manufactured by use of a strip material as a base material of the discharge needle and by coarsely polishing a tip surface of the needle to form a plurality of sharp projections so that discharge may be carried out from the sharp projections thus polished. Conventionally, an acute projection was formed positively. However, even without applying an advanced technique to form a sharp point, polishing a tip of a strip material such as a plate material or a rod to be a discharge needle base material by a coarse file allows a polished edge surface to have a ragged surface and to form a plurality of sharp projections. These sharp projections cause discharge to be generated and therefore using these projections without further processing enables to manufacture a discharge needle at a lower cost. The discharge needle may be formed as the discharge needle alone and provided to the support member. However, a base material of the discharge needle may be provided to a side surface of the support member in advance and a tip surface of the base material of the discharge needle may be polished later.

The present invention has a configuration that the entire surface of a discharge electrode having a support pipe and a discharge needle is coated by a thermoplastic resin layer and the coating layer of a tip surface of the discharge needle is coarsely polished to be removed so that a coarsely-polished discharge edge surface is exposed. Therefore, an effect of improving anti-corrosion property in an electric dust collector can be obtained while accurately ensuring discharging function.

### BRIEF DESCRIPTION OF THE DRAWINGS

FIG. 1 A partial front view of a discharge electrode according to an embodiment.

FIG. 2 A cross-sectional view taken along A-A line in FIG. 1.

FIG. 3 A cross-sectional view taken along B-B line in FIG. 1.

FIG. 4 A partial front view of a discharge electrode before resin coating is carried out.

FIG. 5 A partial front view of a discharge electrode after resin coating is carried out.

FIG. 6 A cross-sectional view taken along C-C line in FIG. 5.

FIG. 7 A perspective view for explanation showing operation of a discharge electrode according to the embodiment.

FIG. 8 An explanatory view showing entrainment condition of resin coating in a discharge needle portion according to the embodiment.

FIG. 9 An explanatory view showing wastage condition of the discharge needle.

FIG. 10 A partial front view of a discharge electrode according to a second embodiment.

FIG. 11 A general perspective view of the discharge electrode according to the second embodiment.

FIG. 12 A partial perspective view of a discharge electrode according to a third embodiment.

FIG. 13 A partial perspective view of a discharge electrode according to a fourth embodiment.

FIG. 14 A cross-sectional view showing configuration of a conventional wet-type electric dust collector.

FIG. 15 A partial front view of a conventional discharge electrode.

### DESCRIPTION OF THE PREFERRED EMBODIMENTS

Hereinafter, preferred embodiments of an electric dust collector, a discharge electrode, a method for producing the discharge electrode, and a method for producing a discharge needle according to the present invention will be explained according to attached figures.

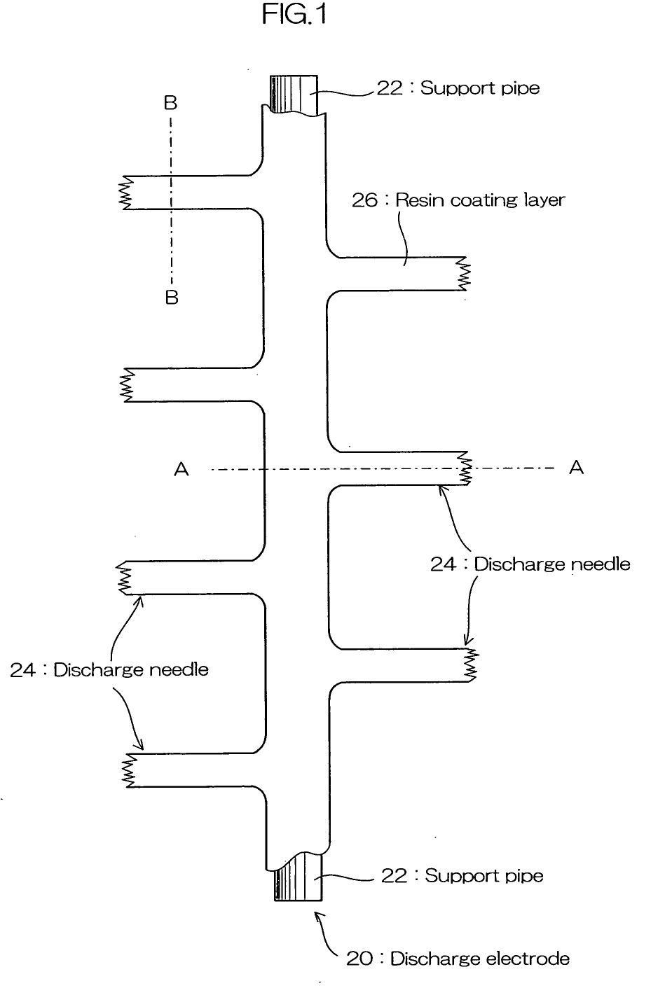

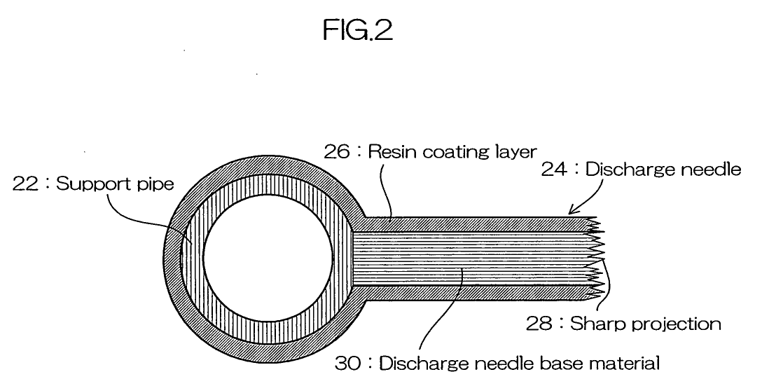

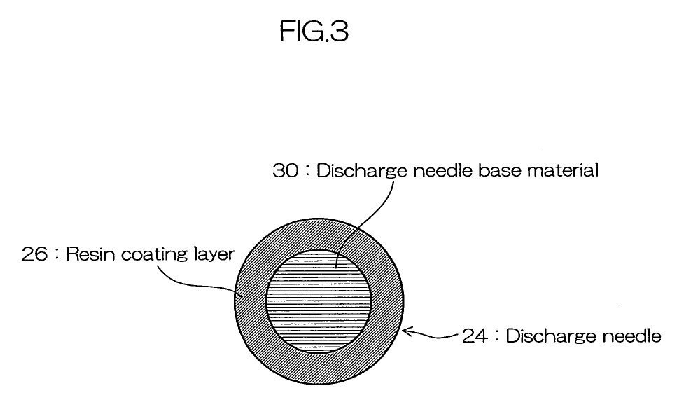

FIG. 1 is a partial front view of a discharge electrode 20 of an electric dust collector as a final product according to an embodiment. FIG. 2 is an enlarged cross-sectional view taken along A-A line in FIG. 1 and FIG. 3 is an enlarged cross-sectional view taken along B-B line in FIG. 1.

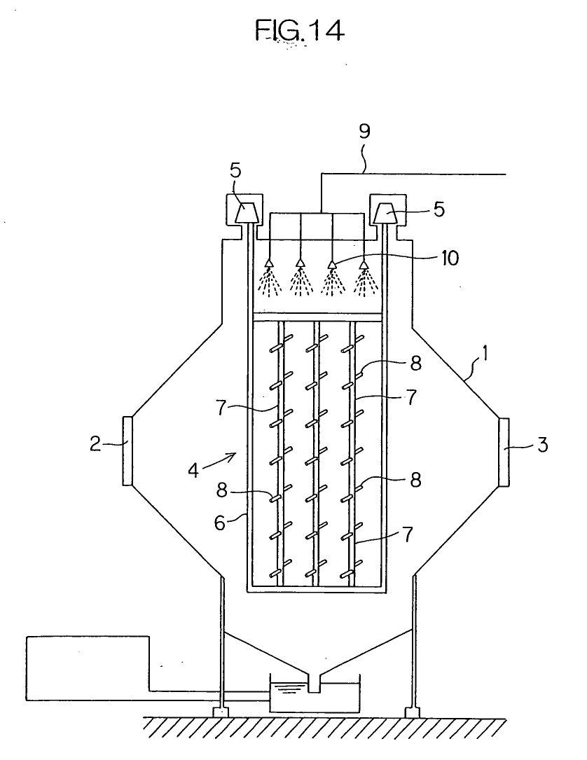

A discharge electrode of an electric dust collector is formed by: forming a rectangular electrode supporting frame hung by a dust collector casing; a plurality of vertical support members are provided in a manner that the support members follow a plain surface inside the frame; and providing a plurality of discharge needles from a side surface of the support member in a direction perpendicular to the frame plain surface so that the needles project with a certain interval (refer to FIG. 14). Therefore, the discharge electrode includes an electrode frame, a support member, and a discharge needle as basic constituents.

A discharge electrode 20 according to the present embodiment includes a pipe 22 as a support member and a plurality of discharge needles 24 provided in a zigzag manner facing opposite directions by 180 degrees as shown in FIGS. 1 to 3. Then, entire surface of such a needle-type rigid discharge electrode is coated by a thermoplastic resin. Thus, a resin coating layer 26 is formed on the whole of the discharge electrode surface. The resin for coating may be any resin as long as the resin has resistance property against mist in a corrosive exhaust gas, such as polyethylene (PE) and polypropylene (PP). The resin coating layer 26 is set to be relatively thicker than the thickness of a support pipe 22. Thus, it becomes possible to reduce ratio of metal of the support pipe 22 or a discharge needle base material 30 to reduce weight of whole of the electric dust collector.

Then, according to the present embodiment, the discharge needle 24 is formed by exposing a coarse discharge edge surface by coarsely polishing the coating layer of a tip surface and as a result of this processing, the exposed edge surface has a jagged surface to have a sharp projection 28 on the edge surface, as shown in FIG. 2. This sharp projection 28 becomes an origin of discharge.

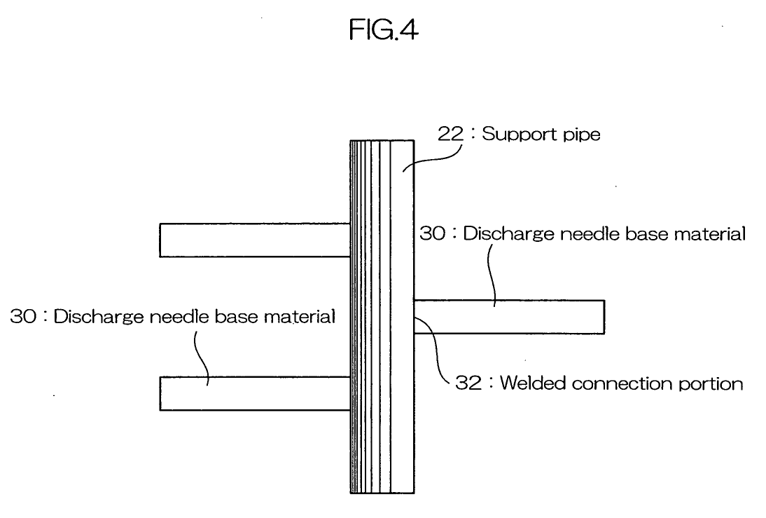

Such a discharge electrode 20 is manufactured as follows. FIG. 4 is a view showing shape of a basic material of the discharge electrode 20 before the resin is coated on the surface thereof. A support member to which the discharge needle 24 is to be attached includes the support pipe 22 and on the surface of the support pipe 22, a columnar metal rod to be a base material 30 of the discharge needle 24 is welded to be connected. No. 32 in the figure is a welded connection portion. A plurality of the discharge needle base materials are attached and as shown in the figure, two rows of the discharge needle 24 are provided in a zigzag manner intervening the support pipe 22 and each row is facing opposite direction with a phase of 180 degrees. Moreover, the discharge needles 24 in each row are provided with an equal space. Here, the discharge needles in the present invention do not need to be aligned in a zigzag manner with an equal space as in FIG. 1 and an arbitrary pattern may be adopted for intentionally setting a corona discharge area.

It is assumed that the base material 30 of the discharge needle 24 is welded to the support pipe 22 to form one unit, or a plurality of the units are welded to be connected with a discharge electrode frame 6 shown in FIG. 14 as a discharge electrode in an approximately final mode. Resin coating is carried out on the surface of these units or the base material assumed to be the discharge electrode. Coating processing may be carried out by a known method and the unit or the base material may be dipped into a tank of molten resin for coating. In a case where the coating is carried out by unit, coating after the unit is welded may be heated to be molten and integrated so that there is no gap between the coating and the unit.

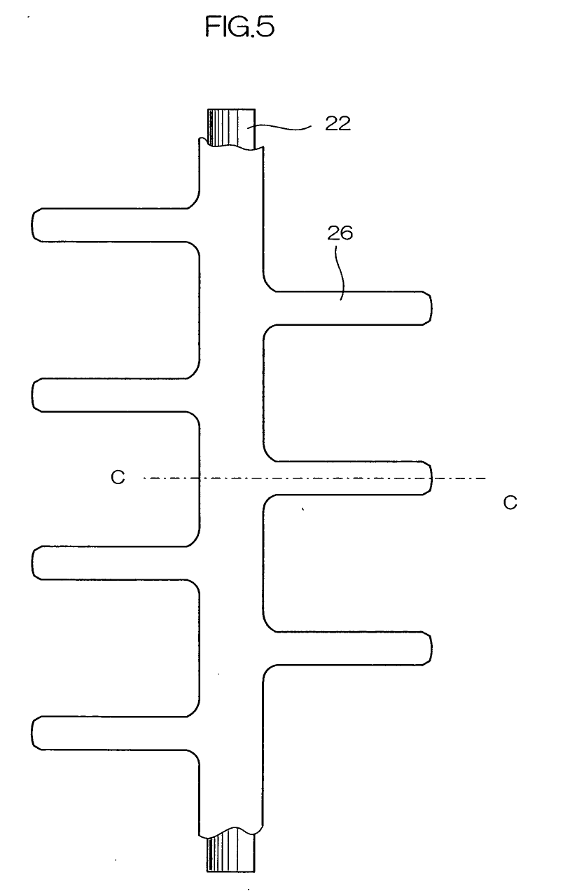

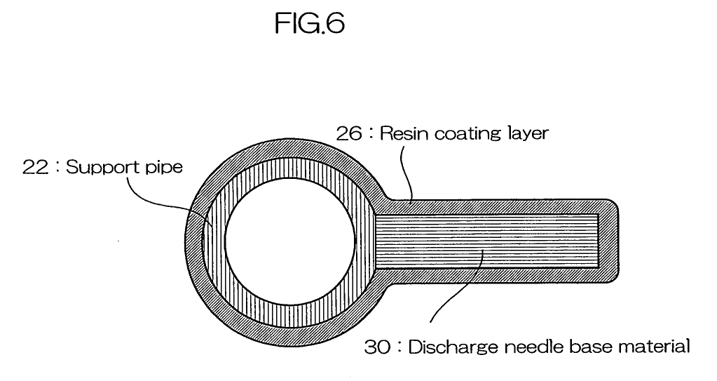

A mode of the unit after resin coating is thus carried out is shown in FIGS. 5 and 6. In such a condition, a tip portion of the discharge needle base material 30 is also coated by the resin coating layer 26. In the present embodiment, the tip portion of the discharge needle base material 30 is coarsely polished for the purpose of exposing a coarsely-polished metal edge surface to form the discharge needle 24. Shape of the discharge electrode before the tip portion of the discharge needle base material 30 is coarsely processed is shown in FIGS. 5 and 6. The tip portion of the discharge needle base material 30 is coarsely polished by a grinder or a grind stone, or is cut by a cutting mechanism together with the resin coating layer 26 so that the coating layer 26 adhering on the tip portion of the discharge needle base material 30 is removed, a tip portion having a sharp projection 28 for discharge is exposed on the tip portion as shown in FIG. 2 to form the discharge needle 24, and corona discharge is enabled.

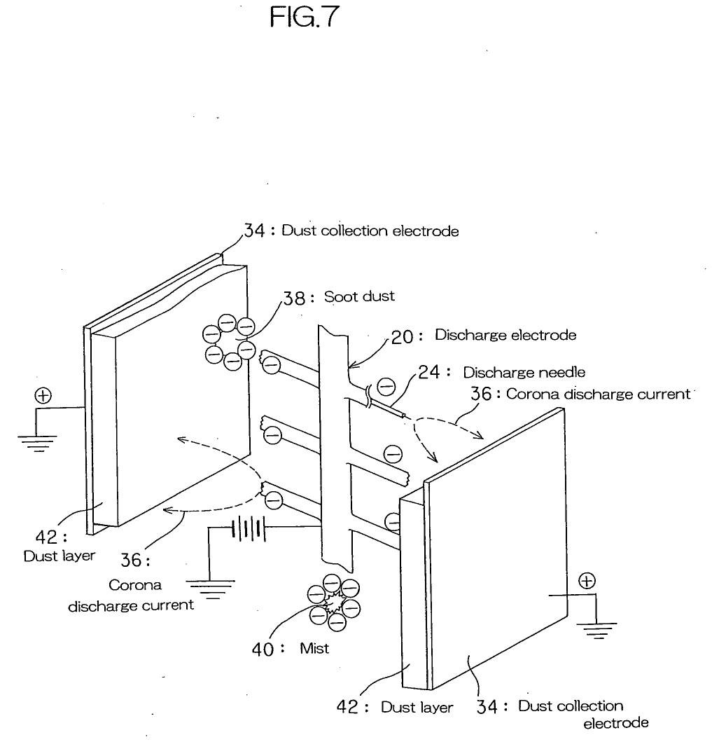

Next, operation of the discharge electrode 20 having the above-mentioned configuration will be explained. The discharge electrode 20 having the above-mentioned configuration is provided in the middle of a dust collection electrode 34 as shown in FIG. 7 in a manner that the discharge needles 24 which are facing opposite direction by 180 degrees respectively face a pair of dust collection electrodes 34. In such a condition, if high voltage is applied to the discharge electrode 20, a corona discharge current 36 toward the dust collection electrode 34 is generated with the sharp projection 28 which is the tip of the discharge needle 24 as an origin. Due to the corona discharge current 36, a soot dust 38 or a mist 40 in the exhaust gas is charged negatively. The soot dust 38 or the mist 40 after charging is pulled by the dust collection electrode 34 having positive charge to form a dust layer 42.

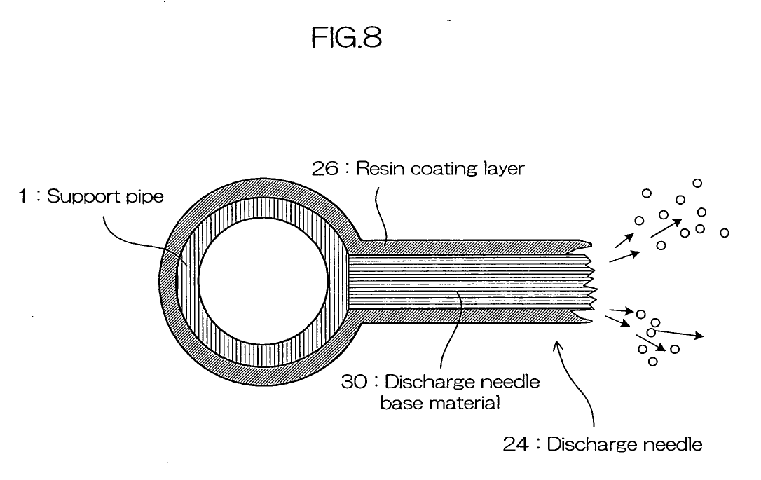

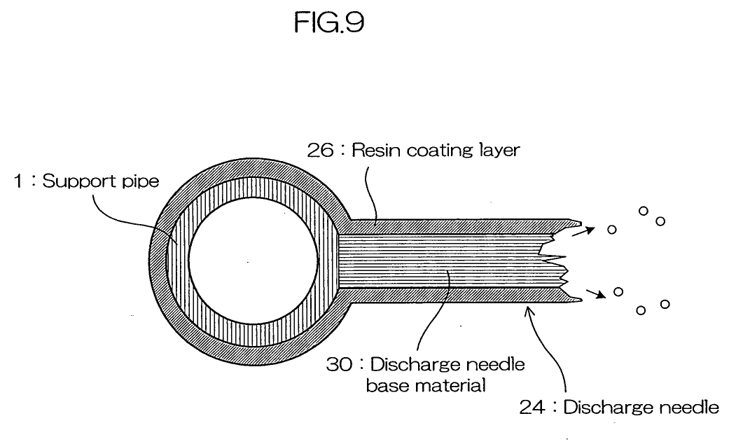

On the tip of the discharge needle in FIG. 2, minute convex or concave portion is generated by the coarse polishing or cutting processing and therefore there always exists the sharp projection 28. If the corona discharge is generated from the tip of the discharge needle 24, as schematically shown in FIG. 8, the resin coating layer 26 in the vicinity of the tip portion of the discharge needle 24 is molten due to heat generated by high voltage. If time elapses, as shown in FIG. 9, the discharge needle 24 is gradually corroded by sulfuric acid included in the dust 38 or the mist 40 in the exhaust gas and tip of the needle is wasted by corrosion. The discharge needle 24 gradually becomes shorter by the wastage by corrosion and the resin coating layer 26 in the vicinity thereof is molten. For easy of understanding, it may be likened to a case where an electrode for arc-welding becomes shorter by arc discharging. It may also be likened to a candle gradually becoming shorter.

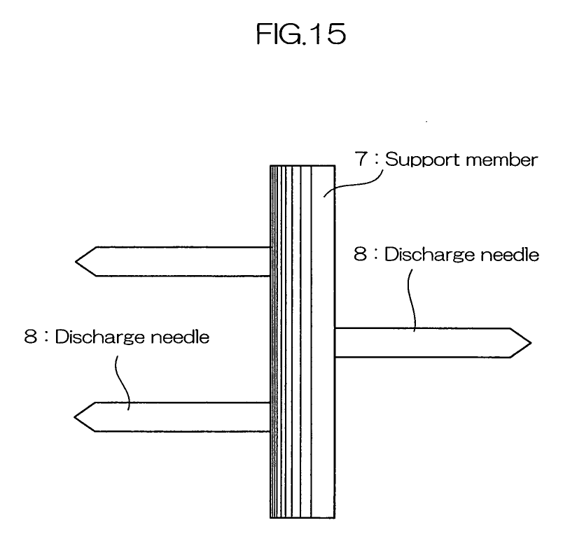

Meanwhile, in the discharge electrode 4 of the conventional art, it is required to sharply process the tip portion of the discharge needle 8 as shown in FIG. 15 for easy of generation of corona discharge. In the present invention, as shown in FIG. 4, shape of the tip of the discharge needle base material 30 does not need to be sharp or does not need to be polished flatly and thinly. It is sufficient only to carry out resin coating and to coarsely polish the tip portion of the discharge needle base material 30 together with the coating. Therefore, steps for processing can be reduced and processing procedure can be easier.

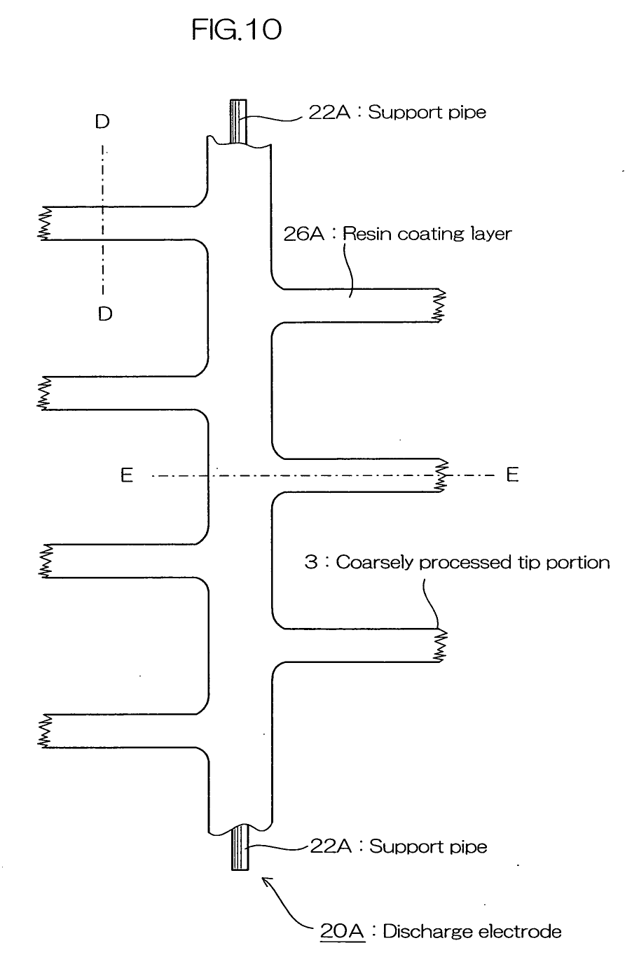

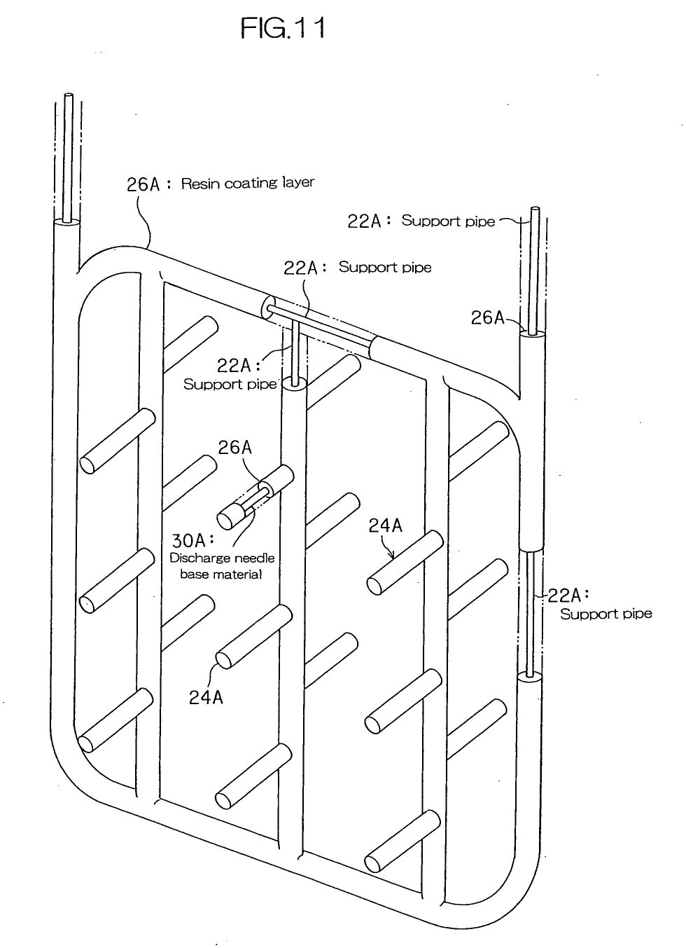

Configuration of a discharge electrode 20A according to a second embodiment is shown in FIGS. 10 and 11. In this embodiment, thickness of a coating layer 26A is set to be thicker than the diameter of a support pipe 22A. Such a configuration enables to reduce weight of the discharge electrode 20A as a whole.

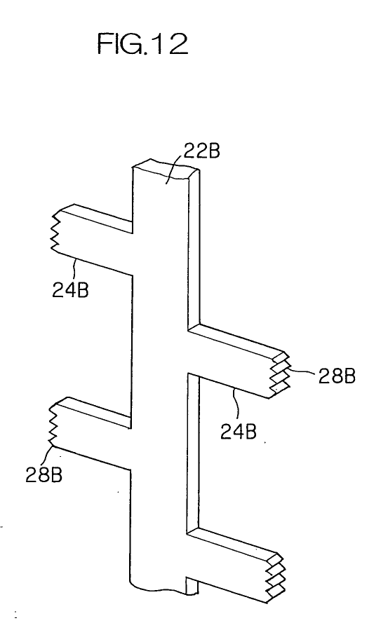

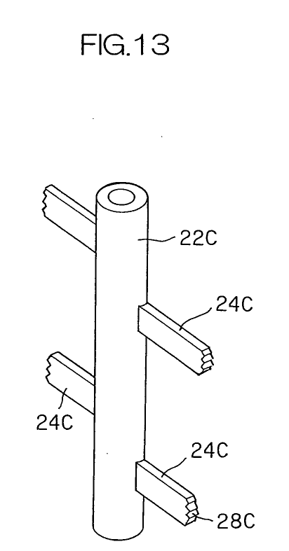

Here, in the above-mentioned embodiments, the discharge electrodes 20 and 20A use the support pipes 22 and 22A respectively. However, as shown in FIG. 12, a plate material may be used as a support member 22B, a plate material to be a discharge needle may be projected from a side edge surface thereof, a projection edge surface of the base material may be coarsely polished to form a sharp projection 28B, and this sharp projection 28B may be a discharge needle 24B. In this case, the support member and the discharge needle base material can be easily manufactured by piercing and processing of the tip of the discharge needle may include only simple coarse polishing. Therefore, manufacturing cost can be lowered. FIG. 13 shows an example where the support member is formed by a support pipe 22C, similarly to the first and the second embodiments, and a discharge needle base material 24C is formed as a plate material. Because processing of the discharge needle includes only by coarse polishing processing, manufacturing cost can be largely reduced. In either case, the discharge electrode base material may use a strip material and it does not matter whether or not the base material is integrated with a support member such as a support pipe.

In the embodiment of FIGS. 12 and 13, it does not matter whether or not resin coating is carried out. These simply show simplification of forming a discharge needle. Needless to say, resin coating may be carried out as in the example of the figure. In this case, polishing coarsely the edge surface of the discharge needle is carried out after the resin coating.

According to the above-described embodiments, since it is not necessary to sharply process the tip portion of a needle of a needle-type rigid discharge electrode, processing procedures in manufacturing can be reduced.

Moreover, if the coating layer can be thicker and the support pipe and the discharge needle can be thinner according to the present embodiment, the discharge electrode can be light-weighted. Therefore, such an electrode is suitable in a case where an electric dust collector is mounted on other equipment such as desulfurization equipment.

Moreover, according to the present embodiment, entire surface of the needle-type rigid discharge electrode is covered with resin coating which not corroded. Therefore, it becomes possible to use stainless steel which is cheap and easy to process under a strong corrosion environment without carrying out cleansing or the like.

According to the present embodiment, it becomes unnecessary to carry out water spraying to a discharge electrode and therefore, as a matter of course, the amount of washing water discharged from an electric dust collector is reduced and size of water processing equipment can be smaller than a conventional art. It becomes possible to reduce the amount of mercury or fluorine discharged to natural environment together with the processing water can be reduced. Therefore it becomes possible to contribute to suppression of destruction of natural environment.

Needless to say, the present embodiment can be applied not only to a wet-type electric dust collector but also to a dry-type one.

What is claimed is:

1. An electric dust collector for removing a corrosive mist in an exhaust gas wherein a whole surface of a needle-type rigid discharge electrode including a support pipe and a discharge needle is coated by a layer of thermoplastic resin and the coating layer of a tip surface of the discharge needle is coarsely polished to remove the coating to expose a coarse discharge edge surface.

2. The electric dust collector according to claim 1,
wherein thickness of the coating layer is thicker than the diameter of the support pipe in the discharge electrode.

3. A discharge electrode comprising a coating layer of thermoplastic resin on a surface of a discharge electrode provided with a discharge projection on a side surface of a support member,
wherein a tip portion of the discharge projection is cut together with the resin coating layer and has an exposed coarse edge surface.

4. The discharge electrode according to claim 3,
wherein the support member includes a pipe and the coating layer is relatively thicker than the pipe.

5. A manufacturing method of a discharge electrode, comprising the steps of:
coating a surface of the discharge electrode with a discharge projection provided on a side surface of a support member by thermoplastic resin; and
cutting coarsely a tip portion of the discharge projection together with the resin coating layer to cause a sharp edge surface of the discharge needle to be exposed outside.

6. A manufacturing method of a discharge needle, comprising the step of:
covering a discharge needle base material with a resin coating and coarsely polishing a tip portion of the discharge needle base material so that a coarsely-polished metal edge surface is exposed to be the discharge needle.

7. A manufacturing method of a discharge needle using a strip material as a base material of the discharge needle,
wherein a tip surface of the needle is coarsely polished to form a plurality of sharp projections so that discharge may be carried out from the sharp projections thus polished.
